(19) United States
(12) Patent Application Publication
(10) Pub. No.: US 2006/0036639 A1
(43) Pub. Date: Feb. 16, 2006

(54) Binning system for data analysis

(76) Inventors: Lars Bauerle, Somerville, MA (US); Johan Lundberg, Savedalen (SE); Tommy Fortes, Goteborg (SE); Anna Lundberg, Savedalen (SE)

Correspondence Address: KRISTOFER E. ELBING, 187 PELHAM ISLAND ROAD, WAYLAND, MA, 01778, US

(21) Appl. No.: 11/173,999

(22) Filed: Jun. 30, 2005

Related U.S. Application Data
(60) Provisional application No. 60/585,219, filed on Jul. 1, 2004.

(51) Int. Cl. G06F 7/00

(52) U.S. Cl. 707/102

(57) ABSTRACT

A system for analyzing data from a database is disclosed. In one general aspect, a binned data representation window is operative to display a binned data representation including bin elements that each correspond to one or more values from the database. A binning control is responsive to user input to adjust the correspondence between bin elements and the values from the database. The binning control is available while the binned data representation window is displayed, and changes to the binning control cause corresponding changes to the binned data representation window.

### CROSS-REFERENCE TO RELATED APPLICATION

This patent application claims the benefit under 35 U.S.C. § 119 (e) of U.S. provisional application No. 60/585,219, filed on Jul. 1, 2004, which is herein incorporated by reference.

### FIELD OF THE INVENTION

This invention relates to the field of data analysis, including the design of data analysis and visualization systems.

### BACKGROUND OF THE INVENTION

The modem world is seemingly flooded with data but is often at a loss for interpreting it. One exceptionally useful tool that has found wide acceptance is software that presents the data in some visual form, especially in a way that makes relationships noticeable. Using this software, often very complex databases can be queried. The results of the queries are then analyzed and displayed in some visual format, usually graphical, such as a bar or pie chart, scatter plot, or any of a large number of other well-known formats. Modem analysis tools then allow the user to dynamically adjust the ranges of the displayed results in order to change and see different aspects of the analysis.

One prominent data visualization product is owned by Spotfire AB of Göteborg, Sweden, and marketed under the name DecisionSite.® In this product, which incorporates the technology disclosed in U.S. Pat. No. 6,014,661 (Ahlberg, et al., “System and method for automatic analysis of data bases and for user-controlled dynamic querying,” issued Jan. 11, 2000, and herein incorporated by reference), query devices tied to columns in the data set and different visualizations of the data allow users to dynamically filter their data sets based on any available property, and hence to interactively visualize the data. As the user adjusts graphical query devices such as rangesliders and alphasliders, the DecisionSite® product changes the visualization of the data accordingly.

The DecisionSite® product also includes several other automatic features, such as initial selection of suitable query devices and determination of ranges, which aid the user not only to visualize the data, but also to mine it. When properly used, this technique constitutes a powerful tool that forms the basis for sophisticated data exploration and decisionmaking applications.

One common visualization format in the DecisionSite® product and others is the bar chart or histogram. These systems have typically operated by allowing the system to select appropriate bin sizes once a user selects visualization of data using a histogram. With some software, the user can direct the system to apply certain bin sizes (that is, widths or ranges).

Overall, analysis and visualization products have improved the efficiency and enhanced the capabilities of professionals in a wide range of areas of data analysis. But these individuals are typically highly trained and highly paid, and they can still spend long periods of time in their data analysis tasks. Improvements in the efficiency of data analysis tasks would therefore be of great benefit to individuals working in a variety of areas.

### SUMMARY OF THE INVENTION

In one general aspect, the invention features a system for analyzing data from a database that includes a binned data representation window operative to display a binned data representation including bin elements that each correspond to one or more values from the database. A binning control is responsive to user input to adjust the correspondence between bin elements and the values from the database. The binning control is available while the binned data representation window is displayed, and changes to the binning control cause corresponding changes to the binned data representation window.

In preferred embodiments, the binning control can be a continuously adjustable control. The binning control can be responsive to actuation by a pointing device, such as a mouse. The binning control can be a slider. The binning control can adjust the number of bins that the system generates for display. The data visualization window can be operative to display a histogram as the binned data representation. Automatic bin characteristics selection logic can be operative to automatically select binning characteristics based on values from the database. The automatic bin characteristics selection logic can always select fewer than the maximum number of bins. The automatic bin characteristics selection logic can be responsive to user input from an automatic binning control.

In another general aspect, the invention features a data analysis method that includes presenting a data analysis window operative to display a binned data representation including a plurality of bin elements each corresponding to one or more values from a database, receiving binning adjustment commands from a user, and adjusting the correspondence between bin elements and the values from the database in the data analysis window.

In a further general aspect, the invention features a system for analyzing data from a database that includes means for presenting a data analysis window operative to display a binned data representation including a plurality of bin elements each corresponding to one or more values from the database, means for receiving binning adjustment commands from a user, and means for adjusting the correspondence between bin elements and the values from the database in the data analysis window.

Systems according to the invention recognize that the process of manually entering ranges for binned data representations can be a tedious process, requiring the user either to think about, choose, and enter into at least one parameter field either the number of bins, the width of bins, or ranges for individual bins.

Although bin width may at first appear to be a trivial choice, its importance in data visualization can be understood by considering the following discussion. If there is a relatively large number of histogram bins (high level of detail), each bin will be relatively small. In fact, given enough bins, the histogram will appear flat, with one or only a few values in each bin. If the number of bins is too small (low level of detail), however, the few included bins may become relatively tall, but the distinctions between them will not be meaningful. In other words, a poor choice of the number of bins can cause a visualization to approach either of two degenerate cases: a great number of bins with at most one value each, or a single “bin” containing all values. Neither extreme provides a useful visualization.

Existing data visualization software generally makes at least the initial choices regarding binning, but the user does not know where between the extremes the choice falls. As mentioned above, however, changing these choices is usually tedious, with no guidance for the user as to which choice of binning will reveal an interesting visualization of the displayed data.

The inventor has discovered that rapidly adjusting the binning can dramatically change how a user sees distributions. This invention involves a mechanism that can allow a user to take advantage of this discovery.

According to the invention, the number of bins (or, equivalently, bin width, level of detail, etc.) in a selected histogram can be made a user-adjustable parameter via a graphical query device such as a slider. This new approach can enable the user to quickly and easily examine and discover the constitution of the distribution represented by the histogram at multiple levels of detail and to locate local distribution maxima and minima that are hidden in views of fewer bins and higher level aggregations. Subtle patterns can thus be discovered in the data that traditional approaches tend not to reveal.

Since existing data visualization software that generates histograms must have some routine for bin selection, the invention is preferably implemented as computer-executable code that is included in such a routine. Thus, rather than accepting an algorithmically determined, static number of bins (again, equivalent to bin widths), or a static value entered specifically into a given data field, the number of bins is encoded using standard programming techniques to be a dynamic parameter that the user enters and adjusts using a graphical input device such as a slider. The DecisionSite® software product is one example of an existing application that automatically generates such sliders and bar charts/histograms and that can easily incorporate the invention. The principles of the invention may also be applied to other data analysis and visualization packages, however, with modifications that are within the abilities of one of ordinary skill in the art to the extent that they are needed.

Normally, a user wants the values on the x-axis of a histogram to be treated as categorical values in bar chart and histogram visualizations. Sometimes, however, a numeric column is used. If this is the case, the options below will be enabled to allow the user to specify how to handle the numeric values in, for example, the DecisionSite® product.

### BRIEF DESCRIPTION OF THE DRAWINGS

FIG. 1 is a diagram of a slider window for an illustrative system according to the invention;

FIG. 2 is a screen shot for the system of FIG. 1 shown in a set-up condition when viewing a numeric variable on the x-axis of a bar chart; and

FIG. 3 is a screen shot for the system of FIG. 2 shown after it has automatically updated a number of bins and visualizations as the user has moved a dynamic auto bin slider.

### DETAILED DESCRIPTION OF AN ILLUSTRATIVE EMBODIMENT

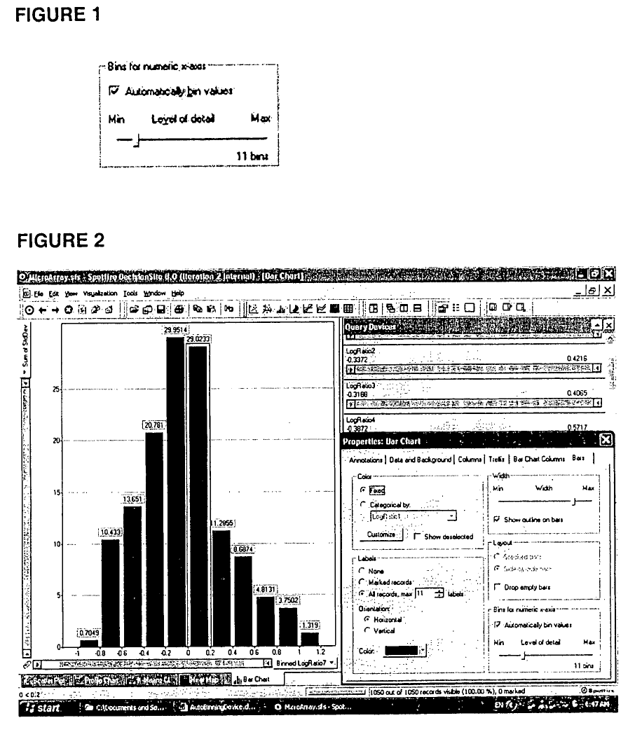

Referring to FIG. 1, an illustrative system according to the invention presents users with a window 10 that contains a slider 12, which allows a user to graphically adjust the number of bins in a given visualization. It also includes an “Automatically bin values” property checkbox 14. If this property is set, the values on the x-axis will be grouped together into bins of equal size. The bins will be generated so that they cover the values of the x-axis column and provide “nice” intervals, defined in any sense implemented by the system designer. In this embodiment, the number of bins generated will be less than a maximum number, which is set using the slider. If the “Automatically bin values” property is not set, the values on the x-axis will be interpreted as categorical values (i.e., just as if they were unique strings). The default behavior when creating bar charts or histograms using a numerical variable on the x-axis is preferably to automatically set up the bins and enable a dynamic “Level of Detail” slider 16.

The “Level of Detail” slider 16 controls the maximum number of bins that can be generated. The actual number of generated bins 18 is shown below the slider. The user can adjust the slider to dynamically change the number of bins displayed. A bar/histogram visualization pane 20 then updates immediately to reflect the set number of bins.

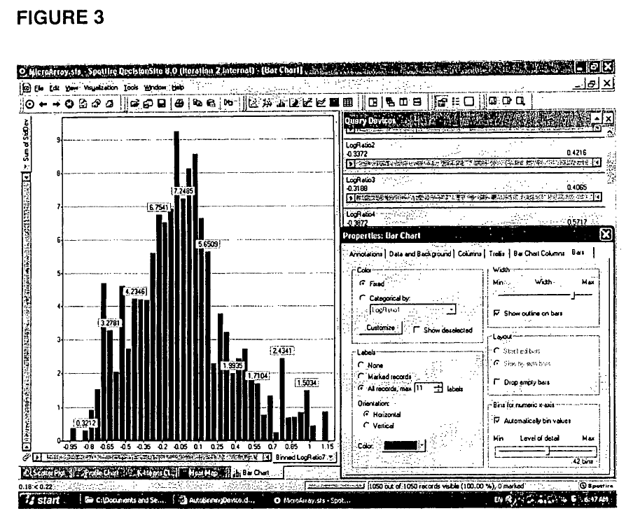

FIG. 2 illustrates how the dynamic auto bin device according to the invention is set up when viewing a numeric variable on the x-axis of a bar chart 22. FIG. 3 shows how the system has automatically updated the number of bins and the visualizations as the user has moved the dynamic auto bin slider 12.

The present invention has now been described in connection with a number of specific embodiments thereof. However, numerous modifications which are contemplated as falling within the scope of the present invention should now be apparent to those skilled in the art. It is therefore intended that the scope of the present invention be limited only by the scope of the claims appended hereto. In addition, the order of presentation of the claims should not be construed to limit the scope of any particular term in the claims.

What is claimed is:

1. A system for analyzing data from a database, comprising:
a binned data representation window operative to display a binned data representation including a plurality of bin elements each corresponding to one or more values from the database,
a binning control responsive to user input to adjust the correspondence between bin elements and the values from the database, and
wherein the binning control is available while the binned data representation window is displayed and wherein changes to the binning control cause corresponding changes to the binned data representation window.

2. The system of claim 1 wherein the binning control is a continuously adjustable control.

3. The system of claim 1 wherein the binning control is responsive to actuation by a pointing device.

4. The system of claim 3 wherein the binning control is a slider.

5. The system of claim 1 wherein the binning control adjusts the number of bins that the system generates for display.

6. The system of claim 1 wherein the data visualization window is operative to display a histogram as the binned data representation.

7. The system of claim 1 further including automatic bin characteristics selection logic operative to automatically select binning characteristics based on values from the database.

8. The system of claim 7 wherein the automatic bin characteristics selection logic always selects fewer than the maximum number of bins.

9. The system of claim 7 wherein the automatic bin characteristics selection logic is responsive to user input from an automatic binning control.

10. A data analysis method, comprising:
presenting a data analysis window operative to display a binned data representation including a plurality of bin elements each corresponding to one or more values from a database,
receiving binning adjustment commands from a user, and
adjusting the correspondence between bin elements and the values from the database in the data analysis window.

11. The method of claim 10 wherein the step of receiving receives binning adjustment commands from a continuously adjustable control.

12. The method of claim 10 wherein the step of receiving receives binning controls from a pointing device.

13. The method of claim 12 wherein the step of receiving receives binning controls from a slider.

14. The method of claim 10 wherein the step of adjusting adjusts the number of bins that the system generates for display.

15. The method of claim 10 wherein the step of presenting displays a histogram as the binned data representation.

16. The method of claim 10 further including the step of automatically selecting binning characteristics based on values from the database.

17. The method of claim 16 wherein the automatic bin characteristics selection step always selects fewer than the maximum number of bins.

18. The method of claim 16 wherein the automatic bin characteristics selection step is responsive to user input from an automatic binning control.

19. A system for analyzing data from a database, comprising:
means for presenting a data analysis window operative to display a binned data representation including a plurality of bin elements each corresponding to one or more values from the database,
means for receiving binning adjustment commands from a user, and
means for adjusting the correspondence between bin elements and the values from the database in the data analysis window.

20. The system of claim 19 wherein the means for presenting displays a histogram as the binned data representation, wherein the means for receiving receives binning adjustment commands from a continuously adjustable slider, wherein the means for adjusting adjusts the number of bins that the system generates for display, and further including means for automatically selecting binning characteristics based on values from the database.
